(19) United States
(12) Patent Application Publication
(10) Pub. No.: US 2023/0094789 A1
(43) Pub. Date: Mar. 30, 2023

(54) DATA DISTRIBUTION IN TARGET DATABASE SYSTEMS

(71) Applicant: International Business Machines Corporation, Armonk, NY (US)

(72) Inventors: Felix Beier, Haigerloch (DE); Einar Lueck, Filderstadt (DE); Dennis Butterstein, Stuttgart (DE); Sabine Perathoner-Tschaffler, Nufringen (DE)

(21) Appl. No.: 17/448,715

(22) Filed: Sep. 24, 2021

(51) Int. Cl. G06F 16/23; G06N 5/02

(52) U.S. Cl. CPC G06F 16/2365; G06N 5/022

(57) ABSTRACT

The present disclosure relates to a method. A value of a characteristic of the distribution of a first set of records of a target table over target database nodes may be determined. A change record describing a change of one or more records of the first set of records and/or one or more new records to be inserted in the target table may be received. Another value of the characteristic of a distribution of a second set of records over the target database nodes in accordance with the first distribution rule may be estimated. In case a difference of the two values exceeds a threshold, a second distribution rule may be determined and the change may be applied and the second set of records may be redistributed according to the second distribution rule; otherwise, the change may be applied in accordance with the first distribution rule.

### BACKGROUND

The present invention relates to the field of digital computer systems, and more specifically, to a method for data distribution in a target database system of a data analysis system.

Replication is a process of maintaining a defined set of data in more than one location. It may involve copying designated changes from one source location to a target location, and synchronizing the data in both locations. The source and target can be in logical servers that are on the same machine or on different machines in a distributed network. Several approaches exist for moving data from one system to another. However, these approaches may need further improvement.

### SUMMARY

Various embodiments provide a method for data distribution in a target database system of a data analysis system, computer system and computer program product as described by the subject matter of the independent claims. Advantageous embodiments are described in the dependent claims. Embodiments of the present invention can be freely combined with each other if they are not mutually exclusive.

In one aspect, the invention relates to a computer implemented method for data distribution in a target database system of a data analysis system, the target database system comprising target database nodes, wherein a first set of records of a target table are distributed over the target database nodes in accordance with a first distribution rule. The method comprises: determining a first value of a characteristic of the distribution of the first set of records over the target database nodes, receiving a change record describing a change of one or more existing records of the first set of records and/or describing one or more new records to be inserted in the target table, determining a second set of records that will result from the application of the change on the target table, estimating a second value of the characteristic of a distribution of the second set of records over the target database nodes in accordance with the first distribution rule, in case a difference of the first and second values exceeds a threshold, determining a second distribution rule and applying the change and redistributing the second set of records over the target database nodes according to the second distribution rule; otherwise applying the change in accordance with the first distribution rule.

In another aspect, the invention relates to a computer program product comprising a computer-readable storage medium having computer-readable program code embodied therewith, the computer-readable program code configured to implement all of steps of the method according to preceding embodiments.

In another aspect, the invention relates to a for data distribution in a target database system of a data analysis system, the target database system comprising target database nodes, wherein a first set of records of a target table are distributed over the target database nodes in accordance with a first distribution rule. The computer system is configured for: determining a first value of a characteristic of the distribution of the first set of records over the target database nodes, receiving a change record describing a change of one or more existing records of the first set of records and/or describing one or more new records to be inserted in the target table, determining a second set of records that will result from the application of the change on the target table, estimating a second value of the characteristic of a distribution of the second set of records over the target database nodes in accordance with the first distribution rule, in case a difference of the first and second values exceeds a threshold, determining a second distribution rule and controlling the target database system to apply the change and redistribute the second set of records over the target database nodes according to the second distribution rule; otherwise controlling the target database system to apply the change in accordance with the first distribution rule.

Embodiments of the present invention also provide related systems, methods, and/or program products.

### BRIEF DESCRIPTION OF THE DRAWINGS

These and other features of this invention will be more readily understood from the following detailed description of the various aspects of the invention taken in conjunction with the accompanying drawings in which:

FIGS. 1A and 1B depict a data analysis system in accordance with an example of the present subject matter.

FIG. 2 is a flowchart of a method for data distribution in a target database system of a data analysis system in accordance with an example of the present subject matter.

FIG. 3 is a flowchart of a method for data distribution in a target database system of a data analysis system in accordance with an example of the present subject matter.

FIG. 4 is a flowchart of a method for data distribution in a target database system of a data analysis system in accordance with an example of the present subject matter.

FIG. 5 represents a computerized system, suited for implementing one or more method steps as involved in the present disclosure.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The data analysis system may, for example, be a data warehousing system or master data management system. The data analysis system may enable data warehousing or master data management or another technique that uses a source and target database systems, wherein the target database system comprises a target database that is configured to receive/comprise a copy of a content of a corresponding source database of the source database system. The source database system may, for example, be a transactional engine and the target database system may be an analytical engine. For example, the source database system may be an online transaction processing (OLTP) system and the target database system may be an online analytical processing (OLAP) system. The source database system may comprise a source dataset and the target database system may comprise a target dataset. The source dataset may be part of a source database and the target dataset may be part of a target database. The source and target datasets may be stored in a same or different format. The formats may differ in encryption, compression, row-oriented vs. column-oriented storage, etc. For example, the source dataset may be stored in a row-oriented format and the target dataset may be stored in a column-oriented format. In other terms, the target dataset may be stored by column rather than by row. The content of the source dataset may be changed by one or more database transactions. The data analysis system may be log-based database replication system.

The target database system may comprise multiple target database nodes. The source database system may be connected to the target database system via a connection to one of the target database nodes. The connection may, for example, be a TCP/IP connection or another connection enabling the communication of data via the connection between the source database system and the target database node. The target database node may comprise one or more database partitions. The database partition may be a part of a table that consists of its own data, indexes, configuration files, and transaction logs. Each of the target database nodes may store records of a table based on a value of a distribution key of the table. A data record or record of a table is a collection of related data items or attributes such as a name, date of birth and class of a particular user. A record represents an entity, wherein an entity refers to a user, object, or concept about which information is stored in the record. The data record may comprise values of a set of attributes. The distribution key of a table may be an attribute or group of attributes that may be used to determine the database partition in which a particular data record of the table is to be stored.

The data analysis system may be configured to replicate changes that occur in a source table of the source database system to the target database system so that said changes may be applied on a target table of the target database system that corresponds to the source table. Applying a change may, for example, comprise inserting one or more records and/or updating one or more records and/or deleting one or more records in one or more tables of the target database system. For that, multiple application algorithms (which may also be referred to as update strategies) may be provided, wherein each application algorithm specifies a sequence of replication operations to be performed in order to apply changes to the target database system. The application algorithms may, for example, comprise an incremental load-based algorithm and a bulk-load based algorithm. The incremental load-based algorithm may propagate changes with a frequency higher than a defined minimum frequency. The incremental load-based algorithm may, for example, require that each recorded change of a log record is applied individually in the target database system. The incremental load-based algorithm may particularly be advantageous for small data sets, because the overhead for large chunks may be high. The bulk-load based algorithm may propagate changes with a frequency smaller than a defined maximum frequency. The bulk load-based application algorithm may, for example, require that the recorded changes of log records are staged into batches. Those batches may then be applied via a bulk load interface to the target database system. The bulk load-based application algorithm may advantageously be used for large datasets. However, the overhead to setup the bulk load may be too high and should not be spent for small-sized chunks that are comprised of just a few rows.

The present subject matter may enable an efficient replication of changes in the data analysis system. The replication is efficient in that the distribution rules are regularly checked and adapted to maintain a balanced distribution of workloads. Indeed, the target database system may, for example, use a data distribution key that is specified on table creation. When updates are processed, the data distribution may change, e.g., the original key may yield a skewed data distribution over the target database nodes. This may lead to imbalances in workload distribution. The present subject matter may detect and correct such imbalances. The present method may automatically be executed and may thus be advantageous compared to an ad-hoc method. This may prevent that database administrators manually analyze query performance to detect whether data distribution imbalances are the reason for performance degradations in order to reorganize the table on the target database system.

According to one embodiment, the first distribution rule comprises a first rule logic having as input a first distribution key of the target table and the target database nodes, wherein the second distribution rule is any one of: the first rule logic having as input a second distribution key and target database nodes of the target database system; a second rule logic having as input the first distribution key and target database nodes of the target database system; or a second rule logic having as input the second distribution key and target database nodes of the target database system. A rule logic of a rule may describe what the rule evaluates and how the evaluation is completed. The rule logic may have components such as Boolean operators, conditions and functions. The rule logic uses the input distribution key and the input target nodes in order to associate the input distribution key to a particular target database node. In one example, the second distribution rule may not use as input the same target database nodes and same number of target database nodes as the first distribution rule. For example, if the new received record would push the size allowed by each node to its maximum, then the second distribution rule may use the same first distribution key and same first rule logic but a higher number of target nodes so that the records may be redistributed over a higher number of nodes and thus the size of records per node may be reduced.

The following example is provided to simplify the description of the embodiment. The first distribution rule may receive as input a distribution key which is a last name of employee records and 12 target database nodes of the target database system. The first distribution rule may assign the last names that start with letter “A” or “B” to the first target node, the last names that start with the letter “C” or “D” to the 2^{th} target node, . . . and the last names that start with the letter “X”, “Y” or “Z” to the 12^{th} target node. That is, each target node is associated with a respective set of characters. The first rule logic, in this case, may compare the first character of the received distribution with the set of characters “A” and “B” and if it matches one of them, the distribution key (and thus the associated record) may be associated with the first target node, otherwise a further check may be performed with the subsequent set of characters and so on until the distribution key is assigned to a target node. The second distribution rule may be derived from the first distribution rule by keeping the same first rule logic i.e., distribution keys which start with specific characters are assigned to respective nodes; and by changing the distribution key to become the first name instead of the last name of the employee records. In another example, the second distribution rule may use a second rule logic different from the first rule logic while keeping the same distribution key, namely the last name. The second rule logic may, for example, evenly distribute the records over the target nodes; that is, for a received distribution key, the second rule logic may determine based on the current distribution of records over the 12 target nodes which target node to receive the new record while maintaining the even distribution of the records.

This embodiment may provide a flexible method to update the distribution of the target table at the target database system.

According to one embodiment, the characteristic is at least one of: the number of records of the target table per target database node, the size of records of the target table per target database node. The characteristic may enable to control the performance of the target database system based on available resources and/or user needs. If, for example, the target database system does not have enough space to store data per node, the characteristic may advantageously be the size of the records as it may enable to control the size reached at each node.

According to one embodiment, the second set of records is any one of: an update of the first set of records, a subset of the first set of records, or the first set of records in addition to new records. If, for example, an insertion operation of a new record is to be performed, this may result in one additional record to be stored in the target database system, and thus the second set of records may comprise the first set of records in addition to the inserted record. If, for example, a delete operation of a record is to be performed, this may result in one record less in the target database system, and thus the second set of records may comprise the first set of records without the deleted record. If, for example, an update operation is to be performed, this may result in the same number of records as the first set of records; however, the content and thus the size of the second set of records may change.

According to one embodiment, the data analysis system is configured for data synchronization between a source database system and the target database system, wherein the change record is received from the source database system in response to a change in a source table of the source database system that corresponds to the target table, thereby propagating the change to the target table. This embodiment may enable a replication system of data.

According to one embodiment, in response to receiving other change records from other sources different from the source database system, applying changes indicated in the other received change records, and revaluating the first value of the characteristic, wherein the difference is computed between the second value and the re-evaluated first value.

According to one embodiment, the data analysis system is configured to propagate the change of the source table to the target table with a first frequency in accordance with an incremental update method and to propagate changes of the source table to the target table with a second frequency smaller than the first frequency in accordance with a bulk load method. The method further comprises: in response to receiving other change records in accordance with the bulk load method, applying changes indicated in the other received change records, and revaluating the first value of the characteristic, wherein the difference is computed between the second value and the re-evaluated first value.

The first set of records may be an initial set of records which may be changed by external sources. These embodiments may enable the computer system to be re-initialized for a particular table when its data changes by external sources that is not covered by the incremental update pipeline, e.g., by bulk loading the table.

According to one embodiment, the method further comprises repeating the method without the determining step of the first value. That is, the first value of the characteristic is determined once at the first execution of the method and used for further iterations.

According to one embodiment, the method further comprises repeating the method, wherein the second set of records of a current iteration becomes the first set of records for a subsequent iteration, wherein the second value of the current iteration becomes the first value for the subsequent iteration.

According to one embodiment, the type of change includes at least one of inserting, deleting or updating a data record.

According to one embodiment, each key of the first and second distribution keys comprising one or more attributes of the target table.

According to one embodiment, the method further comprises repeating the method for each further target table of the target database system.

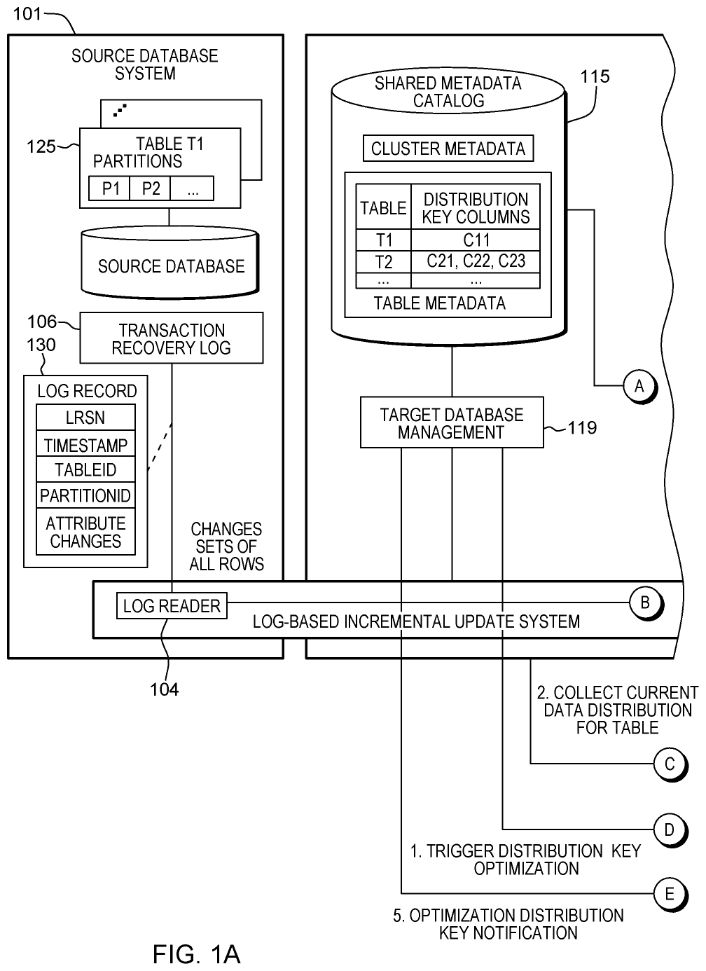

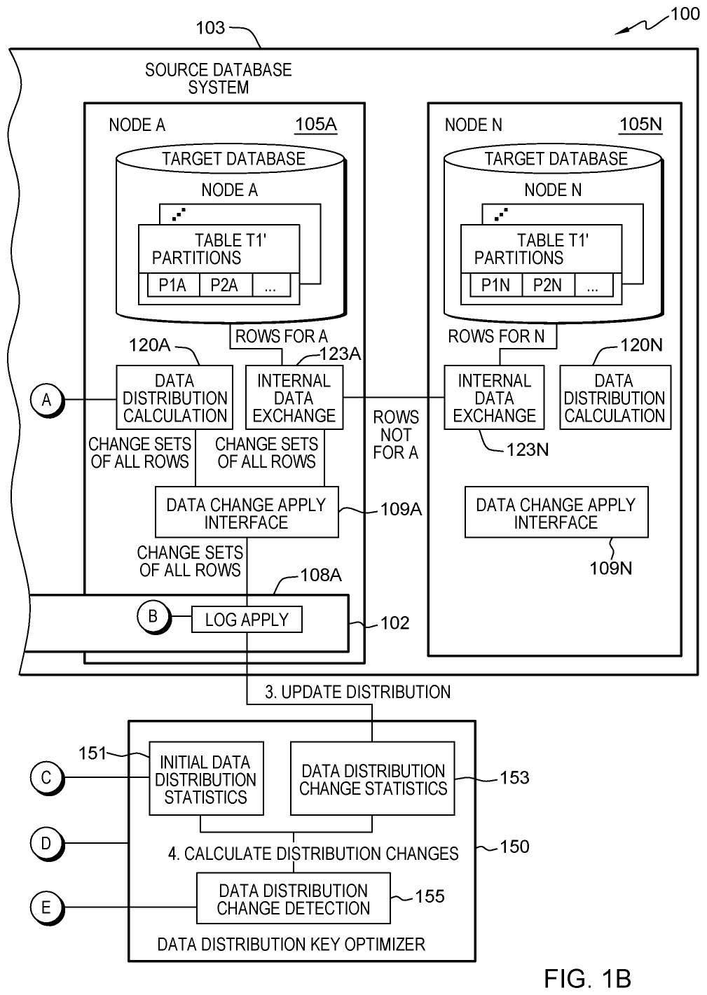

FIG. 1 is a block diagram of a data analysis system 100 in accordance with an example of the present subject matter. The data analysis system 100 may be configured for data synchronization between a source database system 101 and target database system 103 using data synchronization system 102 in accordance with an example of the present subject matter. The source database system 101 may, for example, be an online transaction processing (OLTP) system. The target database system 103 may, for example, be an online analytical processing (OLAP) system.

The source database system 101 comprises one or more source tables 125 of a source database and a transaction recovery log 106. Source tables 125 can be relational tables in DB2® for z/OS®, DB2 for Linux, UNIX, and Windows, and Oracle. The entries (also referred to as log records or change records) of the transaction recovery log 106 describe changes to rows or records of the source tables 125 at the source database system 101. FIG. 1 shows an example content of a change record 130. The change record 130 may comprise a timestamp, log record sequence number (LRSN) and attribute changes. More specifically, the change records in the transaction recovery log 106 may, for example, contain information defining (1) the table being changed, (2) the value of the distribution key in the row being changed, (3) the old and new values of all columns of the changed row, and (4) the transaction (unit of work) causing the change. By definition, an insert is a new data record and therefore has no old values. For delete changes, there is by definition no new data record, only an old data record. Thus, transaction change records for inserted rows may contain only new column values while transaction change records for deleted rows may contain only old column values. Transaction change records for updated rows may contain the new and old values of all row columns. The order of change records in the transaction recovery log 106 may reflect the order of change operations of the transactions. The type of row operations in transaction change records can, for example, be delete, insert or update.

The target database system 103 may comprise a metadata catalog 115 and a target database management system 119. The metadata catalog 115 comprises cluster metadata and table metadata 115. The table metadata comprises information on the distribution rules including distribution keys of the target tables. The cluster metadata comprises information on target nodes such as their number and storage properties. The target database system 103 may comprise N target database nodes 105A-105N, where N≥2. Each of the target database nodes 105A-105N may comprise portions of target tables that correspond to the source tables 125 respectively. As illustrated in FIG. 1, the source table T1 has a corresponding target table T1′. The target table T1′ may be split over and stored on different partitions. For example, some of the rows of the table T1′ may be stored on the target database node 105A e.g., in the partitions P1A and P2A and other rows of the table T1′ may be stored on the target database node 105N e.g., in the partitions P1N and P2N. The content of the target table T1′ and the source table T1 may be synchronized so that changes to the source table T1 may be applied to the target table T1′. An incremental update of the target tables T1′ may be performed so that changes to the source tables T1 are propagated to the corresponding target tables T1′ with a high frequency and just a brief delay (e.g., the frequency of change propagation is higher than a defined minimum frequency); the data synchronization system 102 may thus be referred to as a log-based incremental update system. A target database node such as 105A may comprise an apply program 108A. The apply program 108A may be configured to receive streams of change records e.g., via a log streaming interface, from a log reader 104. The apply program 108A may buffer the received change records and consolidate the changes into batches to improve efficiency when applying the modifications to the target tables of the target database e.g., via a bulk-load interface. In integrated synchronization, the extraction and preparation of the change records into batches may be done single threaded. The apply program 108A may provide the received change records to a distribution module 120A through, for example, data change apply interface 109A. Each of the target database nodes 105A-105N may comprise an data change apply interface 109A-N. Each of the target database nodes 105A-105N may comprise a distribution module 120A-N. The distribution module 120A may determine the target database nodes where the received change records are to be applied. For that, the distribution module 120A may obtain from the metadata catalog 115 the current distribution rule and/or the current distribution key which are associated with the table T1. The distribution module 120A may only request the distribution key if the rule logic is already provided to the distribution module 120A. The distribution module 120A may process each of the received change records in order to read the value(s) of the distribution key and select one of the target database nodes 105A-105N of the target database system 103 where the change record shall be applied according to the current distribution rule. And the exchange module 123A may distribute the received change records to the respective target nodes based on the distribution calculated by the distribution module 120A. Each of the target database nodes 105A-105N may comprise an exchange module 123A-N.

The data synchronization system 102 comprises the log reader 104. Although shown as part of the data synchronization system 102, the log reader 104 may, in another example, be part of the source database system 101. The log reader 104 may read change records of the transaction recovery log 106 and provide them to the apply algorithm 108A.

As described above, the distribution module 120A requests the distribution rule/key from the metadata catalog 115 e.g., after being updated according to the present subject matter. The distribution rules and keys may advantageously be managed and defined according to the present subject matter using a distribution key optimizer 150. The distribution key optimizer 150 may, for example, be triggered by the target database management system 119 in order to perform key optimization for a given table e.g., T1. The distribution key optimizer 150 may be configured to automatically detect shifts in the table's data distribution and take corrective actions. The distribution key optimizer 150 may run on the target database system 103 or another host. For each target table for which the key optimization is triggered, the distribution key optimizer 150 is initialized with the initial data distribution statistics 151. When updates are propagated from the source to the target database system e.g., via the incremental update pipeline, the update is replicated e.g., by the apply algorithm 108A to the distribution key optimizer 150 as additional sink for applying the modifications. This incremental change data is analyzed to maintain differences 153 in the data distribution compared to the initial state, e.g., new values may be inserted into a target node partition or deleted from it. This information is used to detect, e.g., by component 155, shifts in the data distribution by comparing the change statistics to the initial distribution. This can, for example, be used to calculate an optimal distribution key for the current distribution which is sent to the target database management system in order to notify it about the new optimal key which may further be used to apply received change records. In response to this notification, the target database system may alert an administrator to examine this situation or trigger corrective actions, e.g., by reorganizing affected tables. The distribution key optimizer 150 may be initialized to monitor the target table T_{g} after registering it in the target database system. The distribution key optimizer 150 may be re-initialized for a particular table when its data changes by external sources that is not covered by the incremental update pipeline, e.g., by bulk loading the table.

Although shown as separate components, the data synchronization system 102 may, in another example, be part of the source database system 101 or be part of the target database system 103. In one example, the source and target database systems 101 and 103 may be on the same system or on different systems in a distributed network.

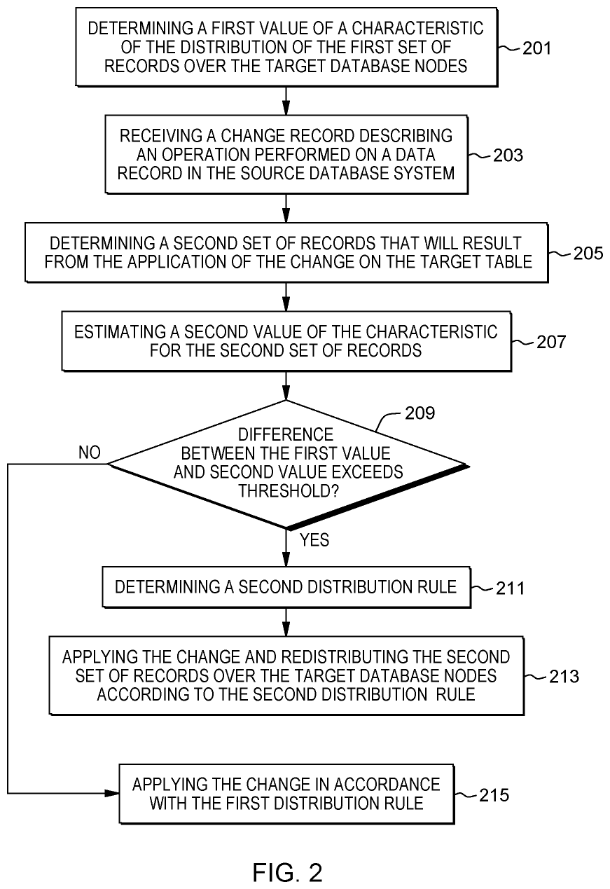

FIG. 2 is a flowchart of a method for distributing data of a target table T_{g} in a target database system. For the purpose of explanation, the method described in FIG. 2 may be implemented in the system illustrated in FIG. 1, but is not limited to this implementation. The method of FIG. 2 may, for example, be performed by the distribution key optimizer 150. The target table T_{g} may store a copy of a source table Tₛ of the source database system 101. For example, the target table T_{g} may comprise a first set of n records e.g., R_{g}¹, R_{g}² . . . R_{g}ⁿ which are distributed over target database nodes of the target database nodes 105A-N according to a first distribution rule. That is, the distribution of the first set of records fulfils the first distribution rule. The first set of records may be referred to as an initial set of records.

A first value of a characteristic of the distribution over the target database nodes of the first set of records R_{g}¹, R_{g}² . . . R_{g}ⁿ may be determined in step 201. The characteristic of the distribution may, for example, be the number of records of the first set of records per target database nodes and/or the size of records of the first set of records in each of the target database nodes and/or the average number of records per target node and/or the average size of records per target node. The first value may be provided in different formats e.g., it may be represented as a distribution curve or as a number or as a vector etc. E.g., if the first set of records are distributed over three target database nodes, the first value may be a vector of three elements indicating the number of records per target node e.g., the first value may be {20, 10, 18} indicating that one target database node has 20 records of the target table T_{g}, a second target database node has 10 records of the target table T_{g}, and a third target database node has 18 records of the target table T_{g}. In another example, the first value may be provided as an average of the number of records per target database node. In another example, the first value may cover more than one characteristic e.g., the first value may indicate the average number of records per target node and the average size of the records per target node. The first value may thus provide one or more initial data distribution statistics. The first value may be extracted from statistics maintained by the target database system if available and/or by executing a query on the target database system that analyses data distribution over the nodes.

At least part of a change record 130 may be received in step 203. The change record may, for example, be received from the source database system in accordance with the incremental update method e.g., the changes at the source table are propagated with a high frequency. The incremental update method may use a dedicated implementation e.g., connection, to provide the changes with the desired frequency, so that the change record may be received through a dedicated incremental update pipeline.

The change record describes a change of one or more existing records of the first set of records and/or describing one or more new records to be inserted in the target table. The at least part of the change record may, in one example, be the whole change record. In another example, the at least part of the change record may be the value of the distribution key of the change record. Indeed, when database changes are replicated to the distribution key optimizer 150, it may be sufficient to project distribution key columns only in order to detect misconfigurations. This may minimize the amount of data that needs to be transferred to the data distribution key optimizer. Thus, receiving only the distribution key may save resources while the distribution key optimizer 150 can still perform optimization of the first distribution rule.

The change record 130 may, for example, describe an operation performed on a data record of the source table Tₛ. If, for example, the operation is an insertion operation, the change record 130 may comprise the inserted data record R_{g}ⁿ⁺¹. If, for example, the operation is an update operation of a data record e.g., R_{g}¹, the change record 130 may comprise the old values of the data record R_{g}¹ and the new values of the data record R_{g}¹. If, for example, the operation is a delete operation of a data record e.g., R_{g}¹, the change record 130 may comprise the old values of the data record R_{g}¹.

The application of the change in accordance with the first distribution rule may result in a second set of records. If, for example, an insertion operation of a new record R_{g}ⁿ⁺¹ is to be performed, this may result in one additional record to be stored in the target database system, and thus the second set of records may comprise the first set of records R_{g}¹, R_{g}² . . . R_{g}ⁿ in addition to the inserted record R_{g}ⁿ⁺¹. If, for example, a delete operation of a record R_{g}¹ is to be performed, this may result in one record less in the target database system, and thus the second set of records may comprise the first set of records without the deleted record R_{g}¹, namely R_{g}² . . . R_{g}ⁿ. If, for example, an update operation is to be performed, this may result in the same number of records as the first set of records; however, the content and thus the size of the second set of records may change. Applying a change to the target table T_{g} in accordance with the first distribution rule means that the change is applied and the distribution of the resulting second set of records fulfils the first distribution rule.

The second set of records may be predicted or determined in step 205. The content of the second set of records may depend on the type of the applied change as described above. However, the distribution of the second set of records over the target database nodes 105A-N according to the first distribution rule may result in changing e.g., shifting, the initial distribution. To detect that, a second value of the characteristic of the distribution of the second set of records over the target database nodes in accordance with the first distribution rule may be estimated in step 207. Following the above simplified example, the distribution of the second set of records may, for example, result in a second value of the characteristic: {21, 10, 18} if one additional record is inserted in the target database system.

It may be determined (inquiry step 209) whether the difference between the first and second value exceeds a threshold. Depending on the format of the characteristic's value, the difference may be determined accordingly. If for example, the value of the characteristic is provided as a vector, the difference between the two vectors may be defined as a similarity measure such as a cosine similarity. If, for example, the value of the characteristic is provided as a distribution, a maximum mean discrepancy method may be used to determine the difference. Thus, the threshold may be defined based on the method used to compute the difference and its value may be provided based on allowed/desired shifts between the characteristic values. For example, if the characteristic is the size of records per node, the threshold may be a maximum size per node.

In case the difference between the first and second value exceeds the threshold, a second distribution rule may be determined in step 211 and provided as an update of the first distribution rule. The second distribution rule may be derived from the first distribution rule by keeping the first rule logic and changing the first distribution key or by changing the first rule logic and changing or maintaining the first distribution key. Assuming, for example, that the first distribution rule enables to distribute the records over the target nodes based on the ages of the employee records e.g., records of employees having an age between 20 and 40 are stored on one target node, records of employees having an age between 40 and 60 are stored on another target node etc. The second distribution rule may use a different logic with the same distribution key, namely the age e.g., the records of employees having an age between 20 and 30 are stored on one target node, records of employees having an age between 30 and 60 are stored on another target node etc.

The change may be applied and the resulting second set of records may be redistributed on the target database nodes 105A-N in step 213 using the second distribution rule. The distribution key optimizer 150 may control or cause the target database system to perform step 213. For example, the distribution key optimizer 150 may update the metadata catalog with the second distribution rule so that the target database system may perform step 213. The apply program 108A may provide the received change record to the distribution module 120A. The distribution module 120A may determine the target database nodes where the received change record is to be applied. For that, the distribution module 120A may obtain the current distribution rule from the metadata catalog 115.

In case the difference between the first and second values does not exceed the threshold, the change may be applied according to the first distribution rule in step 215. The change may be applied and the resulting second set of records may fulfill the first distribution rule. The distribution key optimizer 150 may control or cause the target database system to perform step 215.

The target database system may comprise further target tables T_{g}¹, R_{g}² . . . T_{g}^{x} which replicate the content of the respective source tables Tₛ¹, Rₛ² . . . Tₛ^{x} of the source database system. Each of the further target tables may be distributed on target nodes of the target database system using the same first distribution rule of the target table T_{g} or a different first distribution rule. The method of FIG. 2 may be repeated for each further target table T_{g}¹, T_{g}² . . . T_{g}^{x} of the target database system.

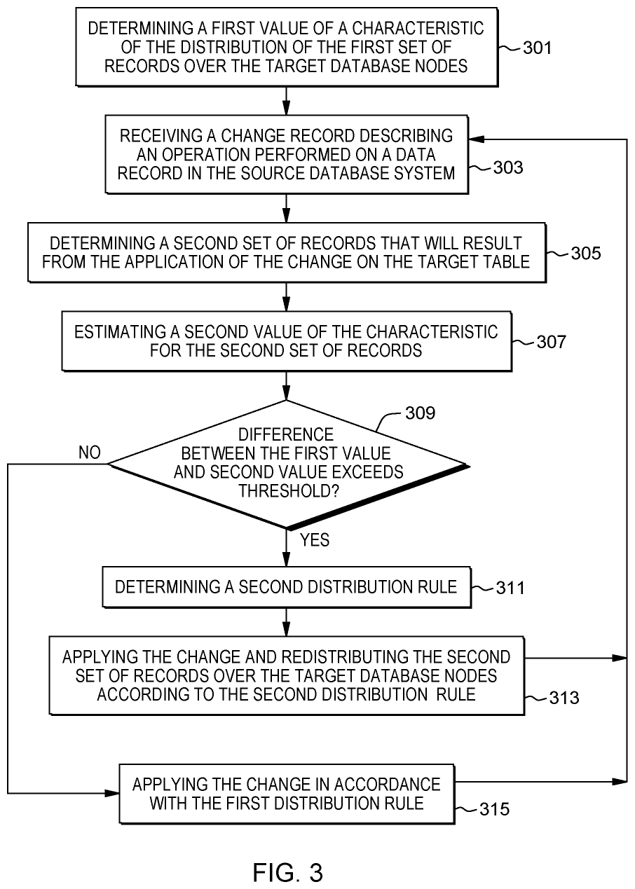

FIG. 3 is a flowchart of a method for distributing data of a target table T_{g} in a target database system. For the purpose of explanation, the method described in FIG. 3 may be implemented in the system illustrated in FIG. 1, but is not limited to this implementation. The method of FIG. 3 may, for example, be performed by the distribution key optimizer 150. The target table T_{g} may store a copy of a source table Tₛ of the source database system 101. For example, the target table T_{g} may comprise a first set of n records e.g., R_{g}¹, R_{g}² . . . R_{g}ⁿ which are distributed over target database nodes of the target database nodes 105A-N according to a first distribution rule. That is, the distribution of the first set of records fulfils the first distribution rule. The first set of records may be referred to as an initial set of records.

The method steps 301 to 315 are the method steps 201 to 215 of FIG. 2 respectively, wherein steps 303 to 315 are repeated for each further received change record. In each iteration, the same first value of the initial set of records is used for computing the difference in step 309. This method may be advantageous as it may provide a single reference point (i.e., first value) for managing the storage at the target database nodes over time.

It may happen that the first set of records is changed by an external source i.e., the initial set of resources has changed. In this case, the first value may be updated or revaluated using the new initial set of records and used for the iterations following this change.

The target database system may comprise further target tables T_{g}¹, R_{g}² . . . T_{g}^{x} which replicate the content of the respective source tables Tₛ¹, Tₛ² . . . Tₛ^{x} of the source database system. Each of the further target tables may be distributed on target nodes of the target database system using the same first distribution rule of the target table T_{g} or a different first distribution rule. The method of FIG. 3 may be repeated for each further target table T_{g}¹, T_{g}² . . . T_{g}^{x} of the target database system.

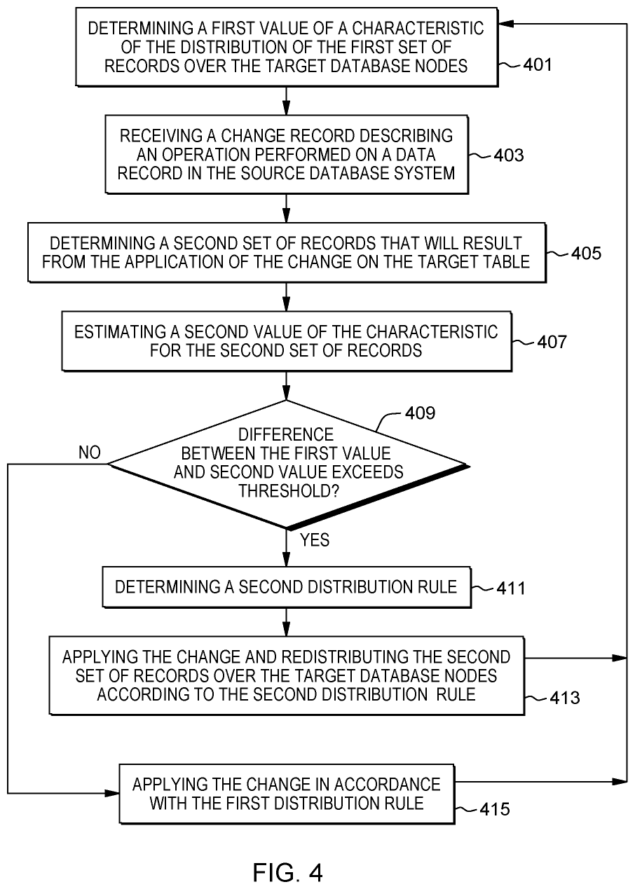

FIG. 4 is a flowchart of a method for distributing data of a target table T_{g} in a target database system. For the purpose of explanation, the method described in FIG. 3 may be implemented in the system illustrated in FIG. 1, but is not limited to this implementation. The method of FIG. 3 may, for example, be performed by the distribution key optimizer 150. The target table T_{g} may store a copy of a source table Tₛ of the source database system 101. For example, the target table T_{g} may comprise a first set of n records e.g., R_{g}¹, R_{g}² . . . R_{g}ⁿ which are distributed over target database nodes of the target database nodes 105A-N according to a first distribution rule. That is, the distribution of the first set of records fulfils the first distribution rule. The first set of records may be referred to as an initial set of records.

The method steps 401 to 415 are the method steps 201 to 215 of FIG. 2 respectively, wherein steps 401 to 415 are repeated for each further received change record and wherein the second set of records of a current iteration becomes the first set of records for the subsequent iteration and the second value of the current iteration becomes thus the first value of the subsequent iteration. This method may be advantageous as it may provide a dynamically adapted reference point for managing the storage at the target database nodes.

The target database system may comprise further target tables T_{g}¹, T_{g}² . . . T_{g}^{x} which replicate the content of the respective source tables Tₛ¹, Tₛ² . . . Tₛ^{x} of the source database system. Each of the further target tables may be distributed on target nodes of the target database system using the same first distribution rule of the target table T_{g} or a different distribution rule. The method of FIG. 4 may be repeated for each further target table T_{g}¹, T_{g}² . . . T_{g}^{x} of the target database system.

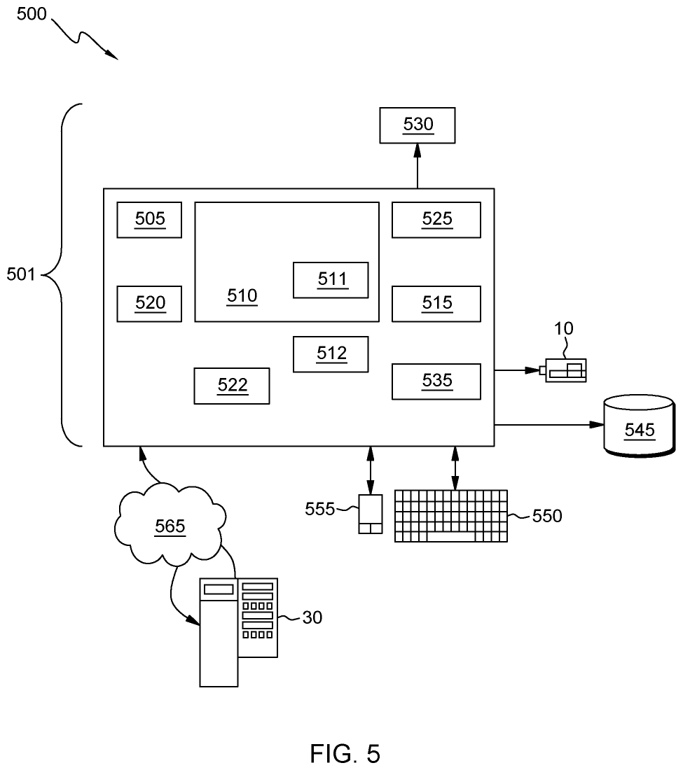

FIG. 5 represents a general computerized system 500 suited for implementing at least part of method steps as involved in the disclosure.

It will be appreciated that the methods described herein are at least partly non-interactive, and automated by way of computerized systems, such as servers or embedded systems. In exemplary embodiments though, the methods described herein can be implemented in a (partly) interactive system. These methods can further be implemented in software 512, 522 (including firmware 522), hardware (processor) 505, or a combination thereof. In exemplary embodiments, the methods described herein are implemented in software, as an executable program, and is executed by a special or general-purpose digital computer, such as a personal computer, workstation, minicomputer, or mainframe computer. The most general system 500 therefore includes a general-purpose computer 501.

In exemplary embodiments, in terms of hardware architecture, as shown in FIG. 5, the computer 501 includes a processor 505, memory (main memory) 510 coupled to a memory controller 515, and one or more input and/or output (I/O) devices (or peripherals) 10, 545 that are communicatively coupled via a local input/output controller 535. The input/output controller 535 can be, but is not limited to, one or more buses or other wired or wireless connections, as is known in the art. The input/output controller 535 may have additional elements, which are omitted for simplicity, such as controllers, buffers (caches), drivers, repeaters, and receivers, to enable communications. Further, the local interface may include address, control, and/or data connections to enable appropriate communications among the aforementioned components. As described herein the I/O devices 10, 545 may generally include any generalized cryptographic card or smart card known in the art.

The processor 505 is a hardware device for executing software, particularly that stored in memory 510. The processor 505 can be any custom made or commercially available processor, a central processing unit (CPU), an auxiliary processor among several processors associated with the computer 501, a semiconductor-based microprocessor (in the form of a microchip or chip set), or generally any device for executing software instructions.

The memory 510 can include any one or combination of volatile memory elements (e.g., random access memory (RAM, such as DRAM, SRAM, SDRAM, etc.)) and non-volatile memory elements (e.g., ROM, erasable programmable read only memory (EPROM), electronically erasable programmable read only memory (EEPROM), programmable read only memory (PROM). Note that the memory 510 can have a distributed architecture, where various components are situated remote from one another, but can be accessed by the processor 505.

The software in memory 510 may include one or more separate programs, each of which comprises an ordered listing of executable instructions for implementing logical functions, notably functions involved in embodiments of this invention. In the example of FIG. 5, software in the memory 510 includes instructions 512 e.g. instructions to manage databases such as a database management system.

The software in memory 510 shall also typically include a suitable operating system (OS) 511. The OS 511 essentially controls the execution of other computer programs, such as possibly software 512 for implementing methods as described herein.

The methods described herein may be in the form of a source program 512, executable program 512 (object code), script, or any other entity comprising a set of instructions 512 to be performed. When a source program, then the program needs to be translated via a compiler, assembler, interpreter, or the like, which may or may not be included within the memory 510, so as to operate properly in connection with the OS 511. Furthermore, the methods can be written as an object-oriented programming language, which has classes of data and methods, or a procedure programming language, which has routines, subroutines, and/or functions.

In exemplary embodiments, a conventional keyboard 550 and mouse 555 can be coupled to the input/output controller 535. Other output devices such as the I/O devices 545 may include input devices, for example but not limited to a printer, a scanner, microphone, and the like. Finally, the I/O devices 10, 545 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices 10, 545 can be any generalized cryptographic card or smart card known in the art. The system 500 can further include a display controller 525 coupled to a display 530. In exemplary embodiments, the system 500 can further include a network interface for coupling to a network 565. The network 565 can be an IP-based network for communication between the computer 501 and any external server, client and the like via a broadband connection. The network 565 transmits and receives data between the computer 501 and external systems 30, which can be involved to perform part, or all of the steps of the methods discussed herein. In exemplary embodiments, network 565 can be a managed IP network administered by a service provider. The network 565 may be implemented in a wireless fashion, e.g., using wireless protocols and technologies, such as WiFi, WiMax, etc. The network 565 can also be a packet-switched network such as a local area network, wide area network, metropolitan area network, Internet network, or other similar type of network environment. The network 565 may be a fixed wireless network, a wireless local area network W(LAN), a wireless wide area network (WWAN) a personal area network (PAN), a virtual private network (VPN), intranet or other suitable network system and includes equipment for receiving and transmitting signals.

If the computer 501 is a PC, workstation, intelligent device or the like, the software in the memory 510 may further include a basic input output system (BIOS) 522. The BIOS is a set of essential software routines that initialize and test hardware at start-up, start the OS 511, and support the transfer of data among the hardware devices. The BIOS is stored in ROM so that the BIOS can be executed when the computer 501 is activated.

When the computer 501 is in operation, the processor 505 is configured to execute software 512 stored within the memory 510, to communicate data to and from the memory 510, and to generally control operations of the computer 501 pursuant to the software. The methods described herein and the OS 511, in whole or in part, but typically the latter, are read by the processor 505, possibly buffered within the processor 505, and then executed.

When the systems and methods described herein are implemented in software 512, as is shown in FIG. 5, the methods can be stored on any computer readable medium, such as storage 520, for use by or in connection with any computer related system or method. The storage 520 may comprise a disk storage such as HDD storage.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method for data distribution in a target database system of a data analysis system, the target database system comprising target database nodes, wherein a first set of records of a target table are distributed over the target database nodes in accordance with a first distribution rule, the method comprising:
determining a first value of a characteristic of the distribution of the first set of records over the target database nodes;
receiving a change record describing a change of one or more existing records of the first set of records and/or describing one or more new records to be inserted in the target table;
determining a second set of records that will result from an application of the change on the target table;
estimating a second value of the characteristic of a distribution of the second set of records over the target database nodes in accordance with the first distribution rule; and
responsive to a difference of the first and second values exceeding a threshold, determining a second distribution rule and applying the change and redistributing the second set of records over the target database nodes according to the second distribution rule; otherwise applying the change in accordance with the first distribution rule.

2. The method of claim 1, the first distribution rule comprising a first rule logic having as input a first distribution key of the target table and target database nodes, wherein the second distribution rule comprises any one of:
the first rule logic having as input a second distribution key and the target database nodes;
a second rule logic having as input the first distribution key and the target database nodes; or
a second rule logic having as input the second distribution key and the target database nodes.

3. The method of claim 1, the characteristic being at least one of:
the number of records of the target table per target database node; and
the size of records of the target table per target database node.

4. The method of claim 1, the second set of records being any one of:
an update of the first set of records,
a subset of the first set of records, or
the first set of records in addition to new records.

5. The method of claim 1, the data analysis system being configured for data synchronization between a source database system and the target database system, wherein the change record is received from the source database system in response to a change in a source table of the source database system that corresponds to the target table, thereby propagating the change to the target table.

6. The method of claim 5, in response to receiving other change records from other sources different from the source database system, applying changes indicated in the other received change records, and revaluating the first value of the characteristic, wherein the difference is computed between the second value and the reevaluated first value.

7. The method of claim 5, wherein the data analysis system is configured to propagate the change of the source table to the target table with a first frequency in accordance with an incremental update method and to propagate changes of the source table to the target table with a second frequency smaller than the first frequency in accordance with a bulk load method; the method further comprising: in response to receiving other change records in accordance with the bulk load method, applying changes indicated in the other received change records, and revaluating the first value of the characteristic, wherein the difference is computed between the second value and the reevaluated first value.

8. The method of claim 1, the method further comprising repeating the method without the determining step of the first value.

9. The method of claim 1, the method further comprising repeating the method, wherein the second set of records of a current iteration becomes the first set of records for a subsequent iteration, wherein the second value of the current iteration becomes the first value for the subsequent iteration.

10. The method of claim 1, wherein a type of the change includes at least one of inserting, deleting or updating a data record.

11. The method of claim 2, each key of the first and second distribution keys comprising one or more attributes of the target table.

12. The method of claim 1, further comprising repeating the method for each further target table of the target database system.

13. A computer program product for data distribution in a target database system of a data analysis system, the target database system comprising target database nodes, wherein a first set of records of a target table are distributed over the target database nodes in accordance with a first distribution rule, the computer program product comprising a computer readable hardware storage device, and program instructions stored on the computer readable hardware storage device, to:
determine a first value of a characteristic of the distribution of the first set of records over the target database nodes;
receive a change record describing a change of one or more existing records of the first set of records and/or describing one or more new records to be inserted in the target table;
determine a second set of records that will result from an application of the change on the target table;
estimate a second value of the characteristic of a distribution of the second set of records over the target database nodes in accordance with the first distribution rule; and
responsive to a difference of the first and second values exceeding a threshold, determine a second distribution rule and applying the change and redistributing the second set of records over the target database nodes according to the second distribution rule; otherwise applying the change in accordance with the first distribution rule.

14. The computer program product of claim 13, the first distribution rule comprising a first rule logic having as input a first distribution key of the target table and target database nodes, wherein the second distribution rule comprises any one of:
the first rule logic having as input a second distribution key and the target database nodes;
a second rule logic having as input the first distribution key and the target database nodes; or
a second rule logic having as input the second distribution key and the target database nodes.

15. The computer program product of claim 13, the characteristic being at least one of:
the number of records of the target table per target database node; and
the size of records of the target table per target database node.

16. The computer program product of claim 13, the second set of records being any one of:
an update of the first set of records,
a subset of the first set of records, or
the first set of records in addition to new records.

17. The computer program product of claim 13, the data analysis system being configured for data synchronization between a source database system and the target database system, wherein the change record is received from the source database system in response to a change in a source table of the source database system that corresponds to the target table, thereby propagating the change to the target table.

18. A computer system for data distribution in a target database system of a data analysis system, the target database system comprising target database nodes, wherein a first set of records of a target table are distributed over the target database nodes in accordance with a first distribution rule, the computer system being configured for:
determining a first value of a characteristic of the distribution of the first set of records over the target database nodes;
receiving a change record describing a change of one or more existing records of the first set of records and/or describing one or more new records to be inserted in the target table;
determining a second set of records that will result from an application of the change on the target table;
estimating a second value of the characteristic of a distribution of the second set of records over the target database nodes in accordance with the first distribution rule;
in case a difference between the first and second values exceeds a threshold, determining a second distribution rule and controlling the target database system to apply the change and redistribute the second set of records over the target database nodes according to the second distribution rule; otherwise controlling the target database system to apply the change in accordance with the first distribution rule.

19. The computer system of claim 18, being comprised in the target database system.

20. The computer system of claim 18, being remotely connected to the target database system.
